(19) United States
(12) Patent Application Publication
(10) Pub. No.: US 2011/0238465 A1
(43) Pub. Date: Sep. 29, 2011

(54) System for Controlling Card Transactions

(76) Inventor: Leesa Shapiro Willet, New York, NY (US)

(21) Appl. No.: 12/731,530

(22) Filed: Mar. 25, 2010

(51) Int. Cl. G06Q 40/00; G06Q 30/00; G06Q 10/00; G06K 5/00; G06F 17/30

(52) U.S. Cl. 705/14.3; 705/14.28; 705/30; 705/41; 235/380; 235/382.5; 707/736; 707/E17.044

(57) ABSTRACT

A system of controlling money through a card, where at least one allocating individual can determine what goods and services the card user may purchase, and what vendors the card user may patronize. The at least one allocating individual accesses a database that is secure and limited to use by the at least one allocating individual. The database permits the at least one allocating individual to select what goods, services and vendors will be accepted and what will be denied when the card is used. These selections are then transmitted to the card company's network, which will accept or decline a purchase request from a vendor. In an additional embodiment, the selections may be transmitted directly to a strip or chip within the card via a card reader or access port such as Universal Serial Bus (USB) located on the card.

### FIELD OF THE PRESENT INVENTION

The present invention relates to a system of controlling the spending of money—particularly in regard to a parent/child relationship—where at least one allocating individual can determine what purchases the card user is allowed to make, and what merchants and vendors the card user is allowed to patronize.

### BACKGROUND OF THE PRESENT INVENTION

Part of growing up is gaining practical knowledge and experience with money. Parents often find that their children are either not responsible in their spending habits or need guidance. Other parents are leery of giving their children cash because they can then purchase virtually anything they want with little supervision. As such, there is a need for a system of controlling money in terms of detached supervision over the purchase of specific goods and services as well as where these items can be bought.

Currently, parents are limited in their options as to distributing money to their children. Credit cards often are not available to children. Parents also often want to shy away from exposing their children (and themselves) to the prospect of credit debt. Secure credit cards exist that permit parents the opportunity to deposit funds into a card. For example, a parent can put $100 into a secure credit card, and the child can then purchase up to $100 worth of goods and merchandise before being overdrawn. Similar items include pay-as-you-go cards and even gift cards to some degree. While there are various pros and cons to these secure credit card variations, the need remains for a system that allows a parent to actually control what is bought and where it is bought from.

There are many reasons for this need. None of the existing methods offer extensive flexibility for parents to control their children's spending based on the values of that particular parent. The present invention solves these needs by allowing parents to determine all relevant factors involved in a purchase. For example, the present invention permits a parent to deny payment access to a physical or online store that sells products deemed unhealthy, inappropriate or even politically/religiously averse based on the parental values being instilled.

U.S. Pat. No. 5,953,710 issued to Fleming on Sep. 14, 1999 is a children's credit or debt card system. Fleming seeks to permit a parent the ability to manage the expenditures a child makes through a card. Unlike the present invention, Fleming relates to managing actual expenditures in terms of monetary transaction. In contrast, the present invention provides a database, whether online or within the computer/personal digital assistant (PDA), that allows at least one allocating individual the ability to manage what goods and services will be accepted and what will be declined upon card use. In addition, the present invention is different in that the at least one allocating individual also determines whether the card will be accepted or declined on a vendor-by-vendor basis.

U.S. Pat. No. 6,173,269 issued to Solokl et al. on Jan. 9, 2001 is a method and apparatus for executing electronic commercial transactions with minors. Solokl uses the Internet so that a card can emulate an ATM machine. In this manner, money is not held within the card service. However, Solokl is contrasted by the present invention in that the present invention provides a database, whether online or within the computer/PDA, that allows at least one allocating individual the ability to manage what goods and services will be accepted and what will be declined upon card use. In addition, the present invention is different in that the at least one allocating individual also determines whether the card will be accepted or declined on a vendor-by-vendor basis.

Managing monetary and spending habits is a constant issue, particularly for parents. But the need remains for a system that allows a parent or supervisor to actually manage what is being purchased or transacted with the card. The present invention solves this need by giving the at least one allocating individual the ability to approve or deny what the card can be used for, and therefore determining what is purchased by the card user.

### SUMMARY OF THE PRESENT INVENTION

The present invention is a system and method for parents to determine what goods and services a child is purchasing, and from what vendors. While the present invention envisions use in the framework of the parent/child dynamic, it also could be used within other supervisory relationships pertaining to monetary allocation and disbursement.

Essentially, the present invention relates to a card that carries some conventional physical attributes to credit cards. The card also may carry conventional attributes similar to identification cards that contain encoded information.

In the context of the parent/child framework, a parent will receive a user name and password to use in conjunction between the card and online/telephonic means. Lists of vendors can be general or further broken down into specific areas of sales, goods and services sold by the vendor. Moreover, specific merchandise and specific services also are made available to the parent in conjunction with the card coding. In addition, a specified monetary amount also is allocated to the card.

### BRIEF DESCRIPTION OF THE DRAWINGS

FIG. 1 is a flow chart of the system of information transfer in the present invention.

FIG. 2 is a flow chart of an embodiment of the present invention.

FIG. 3 is a flow chart of an additional embodiment of the present invention.

### DETAILED DESCRIPTION OF THE PRESENT INVENTION

The present invention is a system for controlling the spending of money. It relates to a card (250) to be carried and used by a child, with a parent setting parameters for the use of the card (250). The child is herein referred to as a card user because, as explained above, the child does not need to be a minor, as the present invention can relate to a ward, young adult or anyone else involved in a subordinate role.

In the preferred embodiment of the present invention, a parent is also referred to as the at least one allocating individual. The at least one allocating individual can be anyone tasked with managing the financial or monetary responsibilities of the card (250) of the present invention. An example is a mother and father, although the option exists to require all of the at least one allocating individuals to consent via online affirmation before a specific action is approved or disapproved. Besides being a parent or guardian, the at least one allocating individual can be any other supervisory authority such as boss, trustee or caretaker. However, the preferred embodiment relates to parental management and education of a child's monetary resources.

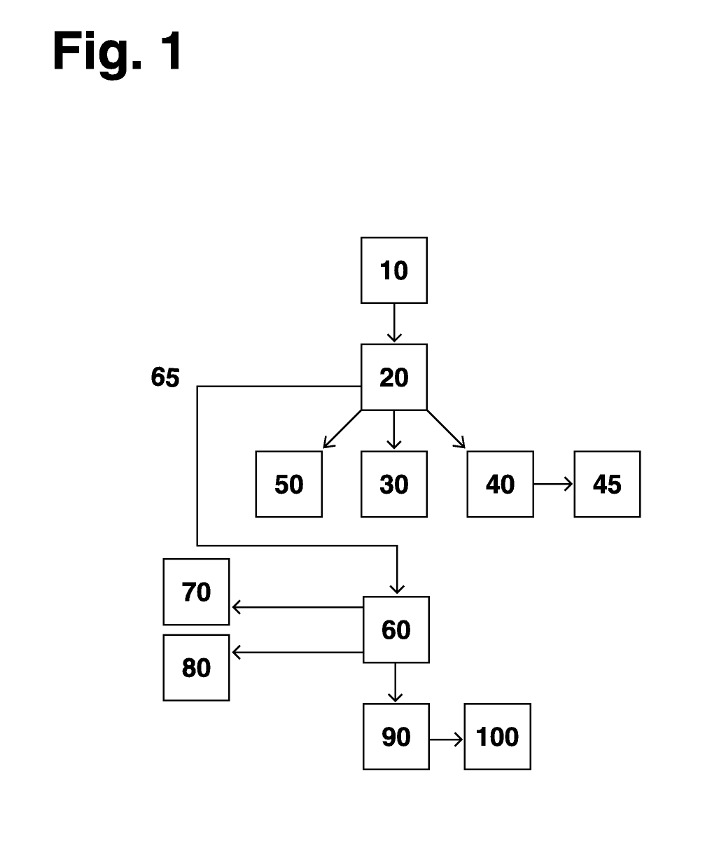

FIG. 1 shows the system of information transfer in establishing the parameters of card usage in the preferred embodiment of the present invention. The parent transmits login information (10) via a device capable of Internet connectivity in order to gain access to a server. The login information includes a username and password for access to the account and to control information contained in a card-linked database (20). Once the parent logs into the card-linked database (20), the parent—or at least one allocating individual—may add or remove merchants and vendors from a vendors list (30). This means that the parent can update the card-linked database (20) to determine which stores, restaurants, entertainment venues, or any other type of vendor will be prohibited or approved to make transactions with the card (250). In other words, the parent will use the card-linked database (20) to limit the card user to specific vendors. For example, the vendors list (30) in the card-linked database (20) may have types of vendors broken down into classifications. This may include eateries, transportation (e.g., subway, railroad, airplane), movie theaters, clothing stores and electronics stores. Furthermore, an additional embodiment breaks down the vendors list (30) within the card-linked database (20) to specific locations. For example, the card-linked database (20) may be linked to a mall directory. In this manner, the parent may add or remove vendors from the vendors list (30) that the parent approves or disapproves of the child frequenting. If a vendor is added, then the card user may make a transaction with that vendor. If a vendor is removed or otherwise disapproved, the transaction will be rejected and not go through, as the card user is prevented from making transactions with that vendor. It also should be noted that the card-linked database (20) of the present invention permits the parent with a secure option to seamlessly add or remove vendors to/from the vendors list (30) at virtually any moment via an Internet connection and device.

In addition, the at least one allocating individual may add to or deduct from the overall monetary balance amount (40) that is available for use with the card (250). For example, a parent may allocate $100 to the card (250) for use by the card user by means of a conventional monetary transfer, taking funds from an existing account and transferring it to the card (250). Moreover, the at least one allocating individual may establish per-vendor monetary limits (45). For example, if $100 is allocated to the overall card (250), the parent may mandate through the card-linked database (20) that transactions at a fast-food restaurant are capped at a fixed amount such as $10, music store transactions are capped at $20, etc. In this manner, the at least one allocating individual may control and limit the extent of purchases from each approved vendor in the vendors list (30).

The present invention also permits the at least one allocating individual the ability to establish per-vendor approved goods and services (50). This means that the at least one allocating individual can use the card-linked database (20) to approve or disapprove of select items or services for sale by specific vendors. For example, within the card-linked database (20) a parent may itemize goods from a drug store so that the card (250) will not complete transactions for the purchase of tobacco products or certain kinds of snacks, or will limit the number of weekly soda purchases, etc. Specific types of music artists, genres or other entertainment classifications purchased online or physically also may be limited or prohibited through the per-vendor approved goods and services (50) function within the card-linked database (20).

After the at least one allocating individual has entered his or her preferences and limitations into the card-linked database (20) as described above, the at least one allocating individual will submit these preferences and limitations, herein called selections (65), via conventional means to the online database network (60) of the card company. The selections (65) are transmitted via conventional means so that the selections (65) reach a nexus between the card (250) and the vendor. The preferred embodiment is to connect the card-linked database (20), updated with the selections (65) of the at least one allocating individual, with the online database network (60) of the card company. For example, if the card was associated with MasterCard™, then the selections (65) will go to the MasterCard™ online database network (60). This means that if the card user attempts to purchase an item that is listed as prohibited in the online database network (60), a decline function (70) is activated at the MasterCard™ system. Conversely, if the card user attempts to make a purchase that is listed as approved in the online database network (60), an accept function (80) is activated at the MasterCard™ system, and the transaction will go through. The same process applies for cards that have more similarity to bank debt cards.

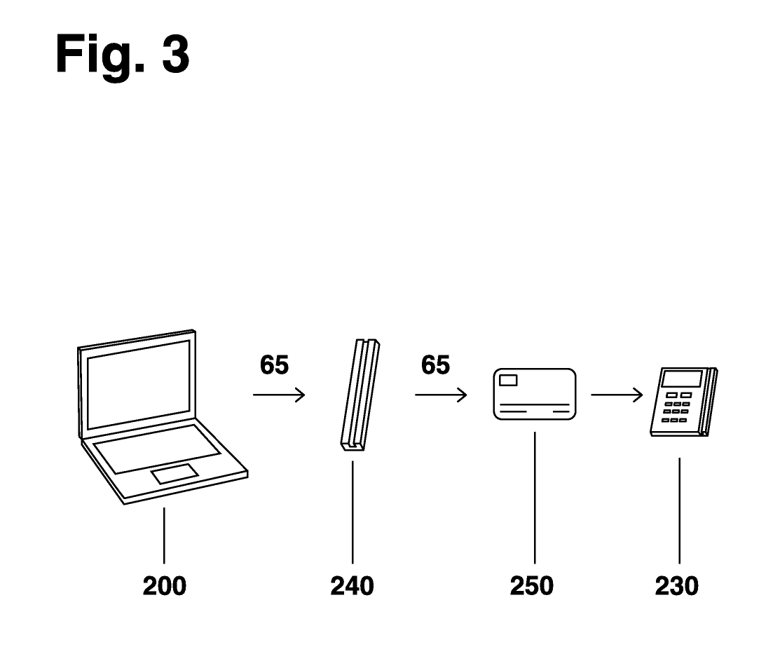

In an additional embodiment, the card (250) has an attached encoding chip or bar. A card reader plugged into the at least one allocating individual's computer (200) will allow the at least one allocating individual to log onto the card-linked database (20) and directly transfer the selections (65) from the computer (200) to the encoding chip or bar via the card reader (see FIG. 3).

The card (250) in the preferred embodiment is formed with an encoded identifying information and tracking system (90). This includes issuing the card (250) with a hologram or photograph of the card user. In addition, medical, address and emergency contact information are encoded into the chip or bar that is attached to the card (250). In an additional embodiment, a GPS tracking device is placed into a portion of the card (250) in order to serve as a locator. In another additional embodiment, a GPS tracking device contained within the card (250) can emit a slight signal while receiving instances of power through the kinetic energy of swiping the card (250), or through a card reader or a small battery. This slight signal can be used to triangulate the position of the card (250) or otherwise locate it.

An additional embodiment of the present invention relates encoded emergency information (100) placed on the card (250). Through conventional means described above, encoded emergency information (100) is transferred into a chip or strip within the card (250), including such medically pertinent information as name of physician, allergies, blood type and other medical issues. This information can be changed by the at least one allocating individual in the same manner as the above items. For example, the at least one allocating member can log onto the card-linked database (20) and change the name of the card user's doctor. Once this information is submitted, the information will be transferred to the card (250) via card reader, or to the online database network (60) of the card company.

An additional embodiment of the present invention relates to a sponsor of the card (250). For example, a vendor can place its logo on the card (250) and otherwise offer incentives for the card user to make purchases. This would be especially pertinent with a vendor that has full card privileges through the at least one allocating individual. Every time the card user makes a transaction with the sponsoring vendor, points, coupons, direct monetary funds or other benefits are conventionally transmitted onto the card (250) directly or transmitted to the online database network (60). Such points or benefits also can be limited by the vendor to vendor-approved outlets or merchandise.

An additional embodiment of the present invention includes denying and approving access to enter specific locations. Such locations include rooms, departments, stores, restaurants, gates, residences, etc. The at least one allocating individual will submit information as described above into the card-linked database (20) relating to the locations, and these specific selections (65) will be forwarded to the online database network (60). The proprietors of these locations will place card readers at the locations' entrances, where the card user will swipe the card (250) into the card reader. Through the processes described above, the card (250) will contact the online database network (60) and activate either the accept function (80) or the decline function (70) based on the specifications of the at least one allocating individual. If the card (250) is accepted, the card user is permitted to enter. If the card (250) is declined, then the card user is denied access to the location. The physical impediment for a declined card (250) is conventional in nature and can be anything from a connected door lock to an alert that notifies a vendor employee. Through the process described above, the at least one allocating individual may instantly change the approved and denied locations through the card-linked database (20), then submit the changed selections (65) to the online database network (60).

It should be noted that the online database network (60) of the present invention can also be linked to Web sites of specific vendors. Such a vendor can present a link for the at least one allocating individual to submit login information (10) as described above and enter the specific vendor's online database. The vendor can organize the content of its Web site to classify its goods and services by age-appropriateness, healthful menu items, or virtually any other classification, and then communicate these selections (65) to the online database network (60). In this manner, the at least one allocating individual can target specific vendors when adding and removing merchandise and services allowed for the card (250). This also permits the card user to make online purchases, since the online database network (60) can easily communicate with the vendor's Web site to approve or deny online transactions based on the selections (65) provided by the at least one allocating individual. In addition, this embodiment relating to online purchases also can apply to the above descriptions as well.

Moreover, an additional embodiment relates to an online service that works in conjunction with the present invention as described above. Expert and industry resources relating to such items as age appropriateness, product analysis, consumer information, dietary information, conventional advice inquiries/responses, and other pertinent information are provided on a Web site linked to the online database. Specific vendors, goods, and services can be either cross-referenced or hyperlinked for quick research as the at least one allocating individual chooses to submit approval or disapproval of specific vendors, goods and services to be applied to the card (250). This embodiment is important for parents who may not be aware of new fads or products that a child may want to purchase.

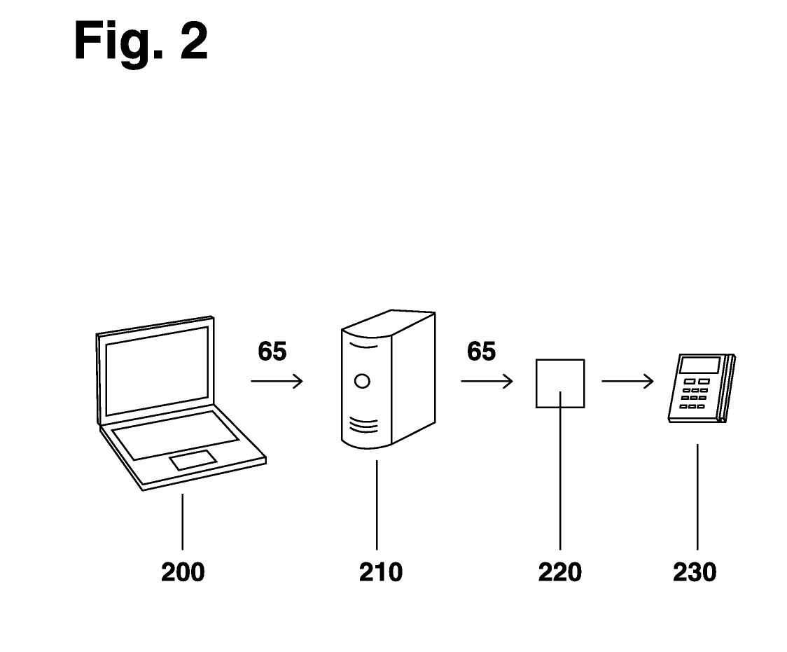

FIG. 2 demonstrates the computer hardware utilization of the preferred embodiment of the present invention, in which the selections (65) of the at least one allocating individual are stored at the online database network (60) of the card company's network (220). In FIG. 2, we see a computing device (200) that the at least one allocating individual can use to enter his or her selections (65). Once the at least one allocating individual submits the selections (65) as described above, the data is transmitted via conventional means to the card-linked database (20) in a server (210) where the database information is housed. These selections (65) are then transmitted via conventional means to the online network database (60) of the card company's network (220), so that when a card (250) is used at a vendor's card reading device (230), either the accept function (80) or the decline function (70) is activated based on information from the online network database (60) (see FIG. 1) of the card company's network (220). The card company's network (220) is the nexus between the card (250) and the vendor.

FIG. 3 illustrates the computer hardware utilized in an embodiment in which the selections (65) of the at least one allocating individual are encoded on the card (250) itself. In this embodiment, the at least one allocating individual enters his or her selections (65) into a card-linked database (20) contained in the internal software and housed in the internal hardware of a computing device (200). A conventional card reading data transfer device (240) is attached to the computer device (200) via conventional means. The card (250) is then swiped or inserted into the card reading data transfer device (240) so that all of the selections (65) as described above can be transferred and updated onto the card (250). From there, data gleaned from a potential transaction, i.e. specific products, vendors, monetary limitations, etc., will be mingled in a nexus when the card (250) is used with the vendor's card reading device (230). Authorization will be granted or denied based on the database information contained in the card (250).

I claim:

1. A system for controlling money, comprising:
receiving login information for at least one allocating individual;
linking a card to a database, the card being authorized for use by a card user;
accessing account and control information contained in the database, the database being accessed via a computing device;
limiting use of the card by the card user to specific merchants and vendors, such limitations being selected by the at least one allocating individual via the database;
permitting the at least one allocating individual to add and remove vendors and merchants that are authorized for use on the card;
raising or reducing overall monetary balance amount of the card, such raising or reductions occurring with selections by the at least one allocating individual being made on the database;
establishing monetary limits toward each vendor and merchant, such limitations occurring through selections made on the database by the at least one allocating individual;
itemizing goods and services at select vendors and merchants, the at least one allocating individual provided the ability via selections on the database to approve and disapprove select items and services for sale at specific establishments;
submitting preferences and limitations for the card into the database after entering desired information, such preferences and limitations being selected by the at least one allocating individual; and
transmitting the desired information from the database so that the selections, preferences and limitations of the card reach a nexus between the card and the merchant or vendor.

2. The system for controlling money of claim 1, further comprising connecting the database and preferences of the at least one allocating individual with a database network of a card company.

3. The system for controlling money of claim 1, further comprising declining authorization for the card if the card user attempts to use the card to make a purchase that was prohibited by the at least one allocating individual via the database.

4. The system for controlling money of claim 1, further comprising approving authorization for the card if the card user attempts to use the card to make a purchase that was within confines of approved parameters by the at least one allocating individual via the database.

5. The system for controlling money of claim 1, further comprising linking the database to the card.

6. The system for controlling money of claim 1, further comprising linking the database to a card network.

7. The system for controlling money of claim 1, further comprising placing the database onto a server to be accessed by the at least one allocating individual via a computing device.

8. The system for controlling money of claim 1, further comprising attaching an encoding chip to the card so that the card can be read by a card reader plugged into the computing device of the at least one allocating individual, therefore allowing the at least one allocating individual to log onto the database and directly transfer selected preferences from the computing device to the encoding chip via the card reader.

9. The system for controlling money of claim 1, further comprising attaching a bar to the card so that the card can be read by a card reader plugged into the computing device of the at least one allocating individual, therefore allowing the at least one allocating individual to log onto the database and directly transfer selected preferences from the computing device to the bar via the card reader.

10. The system for controlling money of claim 1, further comprising forming the card with encoded identifying information about the card user.

11. The system for controlling money of claim 1, further comprising forming the card with encoded tracking information about the card user.

12. The system for controlling money of claim 1, further comprising emitting a slight signal while receiving instances of power through kinetic energy of swiping the card, the slight signal being used to locate a position of the card.

13. The system for controlling money of claim 1, further comprising emitting a slight signal while receiving instances of power through a small battery formed onto the card, the slight signal being used to locate a position of the card.

14. The system for controlling money of claim 1, further comprising emitting a slight signal while receiving instances of power through placing the card in the card reader, the slight signal being used to locate a position of the card.

15. The system for controlling money of claim 1, further comprising sponsoring the card through a sponsoring vendor such that every time the card user uses the card to make a transaction with the sponsoring vendor, benefits are transmitted onto the database for handling by the at least one allocating individual.

16. The system for controlling money of claim 1, further comprising sponsoring the card through a sponsoring vendor such that every time the card user uses the card to make a transaction with the sponsoring vendor, benefits are transmitted onto the card for handling by the at least one allocating individual.

17. The system for controlling money of claim 1, further comprising denying and approving access of the card user to enter specific locations upon swiping the card at an entrance, such denial and approval of access being determined by the at least one allocating individual via the database.

18. The system for controlling money of claim 1, further comprising linking the database to Web sites of specific vendors so that the at least one allocating individual can select and target specific vendors when adding and deducting merchandise for use of the card.

19. A system for controlling money, comprising:
receiving login information for at least one allocating individual;
linking a card to a database, the card being authorized for use by a card user;
accessing account and control information contained in the database, the database being accessed via a computing device;
limiting use of the card by the card user to specific merchants and vendors, such limitations being selected by the at least one allocating individual via the database;
permitting the at least one allocating individual to add and deduct vendors and merchants that are authorized for use on the card;
raising or reducing overall monetary balance amount of the card, such raising or reductions occurring with selections by the at least one allocating individual being made on the database;
establishing monetary limits toward each vendor and merchant, such limitations occurring with selections by the at least one allocating individual being made on the database;
itemizing goods and services at select vendors and merchants, the at least one allocating individual provided the ability via selections on the database to approve and disapprove select items and services for sale at specific establishments;
submitting preferences and limitations of the card into the database after entering desired information, such preferences and limitations being selected by the at least one allocating individual;
transmitting the preferences and limitations selected so that the preferences and limitations of the card reach a nexus between the card and the merchant and vendor;
further comprising connecting the database and selections of the at least one allocating individual with a database network of a card company;
further comprising declining authorization for the card if the card user attempts to use the card to make a purchase that was prohibited by the at least one allocating individual via the database;
further comprising approving authorization for the card if the card user attempts to use the card to make a purchase that was within the confines of parameters approved by the at least one allocating individual via the database;
further comprising linking the database to the card;
further comprising linking the database to a card network;
further comprising placing the database onto a server to be accessed by the at least one allocating individual via a computing device;
further comprising attaching an encoding chip to the card so that the card can be read by a card reader plugged into the computing device of the at least one allocating individual, therefore allowing the at least one allocating individual to log in onto the database and directly transfer selected preferences from the computing device to the encoding chip via the card reader;
further comprising attaching a bar to the card so that the card can be read by a card reader plugged into the computing device of the at least one allocating individual, therefore allowing the at least one allocating individual to log in onto the database and directly transfer selected preferences from the computing device to the bar via the card reader;
further comprising forming the card with encoded identifying information about the card user;
further comprising forming the card with encoded tracking information about the card user;
further comprising emitting a slight signal while receiving instances of power through kinetic energy of swiping the card, the slight signal being used to locate the position of the card;
further comprising emitting a slight signal while receiving instances of power through a small battery formed onto the card, the slight signal being used to locate the position of the card;
further comprising emitting a slight signal while receiving instances of power through placing the card in the card reader, the slight signal being used to locate the position of the card;
further comprising sponsoring the card through a sponsoring vendor such that every time the card user uses the card to make a transaction with the sponsoring vendor, benefits are transmitted onto the database for handling by the at least one allocating individual;
further comprising sponsoring the card through a sponsoring vendor such that every time the card user uses the card to make a transaction with the sponsoring vendor, benefits are transmitted onto the card for handling by the at least one allocating individual;
further comprising authorizing and denying the card user access to specific locations upon swiping the card at an entrance, such authorization and denial of access being determined by the at least one allocating individual via the database; and
further comprising linking the database to Web sites of specific vendors so that the at least one allocating individual can select and target specific vendors when adding and removing merchandise for use of the card.
